(19) United States
(12) Patent Application Publication
(10) Pub. No.: US 2024/0193540 A1
(43) Pub. Date: Jun. 13, 2024

(54) SELECTING PICKERS FOR SERVICE REQUESTS BASED ON OUTPUT OF COMPUTER MODEL TRAINED TO PREDICT ACCEPTANCES

(71) Applicant: Maplebear Inc. (dba Instacart), San Francisco, CA (US)

(72) Inventors: Krishna Kumar Selvam, San Francisco, CA (US); Ali Soltani Sobh, Oakland, CA (US); Kevin Charles Ryan, San Francisco, CA (US); Bing Hong Leonard How, South San Francisco, CA (US); Rahul Makhijani, Daly City, CA (US); Bita Tadayon, Dallas, TX (US)

(21) Appl. No.: 18/079,317

(22) Filed: Dec. 12, 2022

(51) Int. Cl. G06Q 10/087; G06N 20/00

(52) U.S. Cl. CPC G06Q 10/087; G06N 20/00

(57) ABSTRACT

An online concierge system accesses and applies a model to predict likelihoods of acceptance of a service request for an order by pickers. The system accesses timespan distributions for accepted service requests and identifies sets of pickers based on the order. Based on the likelihoods and distributions, the system generates simulated responses of the sets of pickers to the service request and trains an additional model based on attributes of the order, the simulated responses, and information associated with corresponding sets of pickers. The system receives a new order, identifies additional sets of pickers based on the new order, and applies the additional model to predict responses of the additional sets of pickers to an additional service request for the new order. Based on the predicted responses and a delivery time associated with the new order, a minimum number of pickers to send the additional service request is determined.

### BACKGROUND

Online concierge systems allow customers to place online delivery orders and match the orders with pickers who service the orders on behalf of the customers. Pickers may service orders by performing different tasks involved in servicing the orders, such as driving to retailer locations, collecting items included in the orders, purchasing the items, and delivering the items to customers. Once an online concierge system receives an order from a customer, the online concierge system may send a service request to several pickers available to service the order, notifying them that the order is available for servicing. The order may then be assigned to the first picker who accepts the service request.

To reduce the risk that orders will be delivered late and to reduce costs, online concierge systems often send service requests to pickers based on the pickers' proximities to retailer locations associated with orders. For example, suppose that an online concierge system receives an order that includes items to be collected from a retailer location and a picker is already waiting in the parking lot for the retailer location. In this example, the online concierge system is more likely to send a service request for the order to this picker than to other pickers since pickers may be compensated based on the distances they travel to service orders and pickers who are closer to retailer locations from which items included in orders are to be collected are usually able to service the orders faster than pickers who are further away.

If service requests are not accepted by pickers within a certain amount of time, online concierge systems may then send the service requests to additional pickers who are progressively further away from retailer locations from which items included in the corresponding orders may be collected until the service requests are eventually accepted. However, as the service requests are sent to more pickers, the risk that the orders are delivered late increases since the amount of time it takes for the service requests to be accepted also increases and the pickers who eventually accept the service requests are more likely to be further from the retailer locations. Although online concierge systems initially may send the service requests to more pickers, doing so may also increase costs and introduce other complications that may degrade service quality.

### SUMMARY

In accordance with one or more aspects of the disclosure, an online concierge system determines a minimum number of pickers to which to send a service request for an order placed with the online concierge system. More specifically, the online concierge system accesses a first machine learning model trained to predict a likelihood that a picker will accept a service request for an order placed with the online concierge system and applies the first machine learning model to predict the likelihood that each picker of a plurality of pickers will accept a first service request for a first order. The online concierge system then accesses a distribution of timespans between a sending and an acceptance of a service request for one or more previous orders for one or more pickers of the plurality of pickers. The online concierge system identifies a first plurality of sets of pickers from the plurality of pickers based on a first retailer location associated with the first order, in which each set of pickers of the first plurality of sets of pickers includes a first number of pickers associated with a set of locations within a first radius of the first retailer location and the first number of pickers is proportional to the first radius. The online concierge system generates a simulated response of each set of pickers included among the first plurality of sets of pickers to the first service request based on the likelihood that each picker will accept the first service request for the first order and the distribution of timespans.

A second machine learning model is trained to predict a response of a set of pickers to a service request based on a set of attributes of the first order, the simulated response generated for each set of pickers of the first plurality of sets of pickers, and a corresponding first number of pickers and first radius. The online concierge system then receives a new order and identifies a second plurality of sets of pickers from the plurality of pickers based on a second retailer location associated with the new order, in which each set of pickers of the second plurality of sets of pickers includes a second number of pickers associated with a set of locations within a second radius of the second retailer location and the second number of pickers is proportional to the second radius.

For each set of pickers of the second plurality of sets of pickers, the online concierge system applies the second machine learning model to predict the response of a corresponding set of pickers to a second service request for the new order based on the set of attributes of the new order and a corresponding second number of pickers and second radius. Based on the response predicted for each set of pickers and a delivery time associated with the new order, the online concierge system determines a minimum number of pickers to send the second service request for the new order.

### BRIEF DESCRIPTION OF THE DRAWINGS

FIG. 1 illustrates an example system environment for an online concierge system, in accordance with one or more embodiments.

FIG. 2 illustrates an example system architecture for an online concierge system, in accordance with one or more embodiments.

FIG. 3 is a flowchart of a method for determining a minimum number of pickers to send a service request for an order placed with an online concierge system, in accordance with one or more embodiments.

FIG. 4 illustrates examples of pickers associated with locations within different radii of different retailer locations, in accordance with one or more embodiments.

FIGS. 5A-5C illustrate examples of graphs for determining a minimum number of pickers to send a service request for an order placed with an online concierge system, in accordance with one or more embodiments.

### DETAILED DESCRIPTION

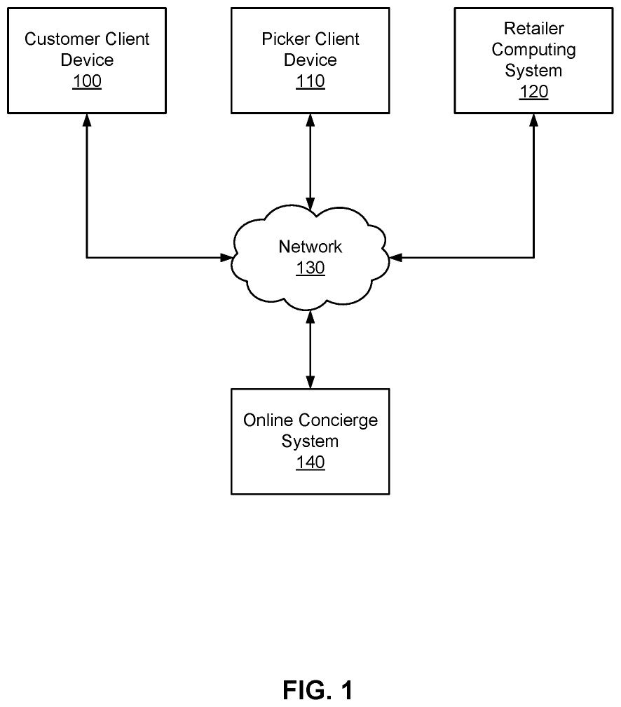

FIG. 1 illustrates an example system environment for an online concierge system 140, in accordance with one or more embodiments. The system environment illustrated in FIG. 1 includes a customer client device 100, a picker client device 110, a retailer computing system 120, a network 130, and an online concierge system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

As used herein, customers, pickers, and retailers may be generically referred to as “users” of the online concierge system 140. Additionally, while one customer client device 100, picker client device 110, and retailer computing system 120 are illustrated in FIG. 1, any number of customers, pickers, and retailers may interact with the online concierge system 140. As such, there may be more than one customer client device 100, picker client device 110, or retailer computing system 120.

The customer client device 100 is a client device through which a customer may interact with the picker client device 110, the retailer computing system 120, or the online concierge system 140. The customer client device 100 can be a personal or mobile computing device, such as a smartphone, a tablet, a laptop computer, or a desktop computer. In some embodiments, the customer client device 100 executes a client application that uses an application programming interface (API) to communicate with the online concierge system 140.

A customer uses the customer client device 100 to place an order with the online concierge system 140. An order specifies a set of items to be delivered to the customer. An “item,” as used herein, means a good or product that can be provided to the customer through the online concierge system 140. The order may include item identifiers (e.g., a stock keeping unit or a price look-up code) for items to be delivered to the customer and may include quantities of the items to be delivered. Additionally, an order may further include a delivery location to which the ordered items are to be delivered and a window (e.g., a timeframe or period of time) during which the items should be delivered. In some embodiments, the order also specifies one or more retailers from which the ordered items should be collected.

The customer client device 100 presents an ordering interface to the customer. The ordering interface is a user interface that the customer can use to place an order with the online concierge system 140. The ordering interface may be part of a client application operating on the customer client device 100. The ordering interface allows the customer to search for items that are available through the online concierge system 140 and the customer can select which items to add to a “shopping list.” A “shopping list,” as used herein, is a tentative set of items that the user has selected for an order but that has not yet been finalized for an order. The ordering interface allows a customer to update the shopping list, e.g., by changing the quantity of items, adding or removing items, or adding instructions for items that specify how the items should be collected.

The customer client device 100 may receive additional content from the online concierge system 140 to present to a customer. For example, the customer client device 100 may receive coupons, recipes, or item suggestions. The customer client device 100 may present the received additional content to the customer as the customer uses the customer client device 100 to place an order (e.g., as part of the ordering interface).

Additionally, the customer client device 100 includes a communication interface that allows the customer to communicate with a picker that is servicing the customer's order. This communication interface allows the user to input a text-based message to transmit to the picker client device 110 via the network 130. The picker client device 110 receives the message from the customer client device 100 and presents the message to the picker. The picker client device 110 also includes a communication interface that allows the picker to communicate with the customer. The picker client device 110 transmits a message provided by the picker to the customer client device 100 via the network 130. In some embodiments, messages sent between the customer client device 100 and the picker client device 110 are transmitted through the online concierge system 140. In addition to text messages, the communication interfaces of the customer client device 100 and the picker client device 110 may allow the customer and the picker to communicate through audio or video communications, such as a phone call, a voice-over-IP call, or a video call.

The picker client device 110 is a client device through which a picker may interact with the customer client device 100, the retailer computing system 120, or the online concierge system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online concierge system 140.

The picker client device 110 receives orders from the online concierge system 140 for the picker to service. A picker services an order by collecting the items listed in the order from a retailer location. The picker client device 110 presents the items that are included in the customer's order to the picker in a collection interface. The collection interface is a user interface that provides information to the picker on which items to collect for a customer's order and the quantities of the items. In some embodiments, the collection interface provides multiple orders from multiple customers for the picker to service at the same time from the same retailer location. The collection interface further presents instructions that the customer may have included related to the collection of items in the order. Additionally, the collection interface may present a location of each item in the retailer location, and may even specify a sequence in which the picker should collect the items for improved efficiency in collecting items. In some embodiments, the picker client device 110 transmits to the online concierge system 140 or the customer client device 100 which items the picker has collected in real time as the picker collects the items.

The picker can use the picker client device 110 to keep track of the items that the picker has collected to ensure that the picker collects all of the items for an order. The picker client device 110 may include a barcode scanner that can determine an item identifier encoded in a barcode coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and determines the item identifier for the item based on the images. The picker client device 110 may determine the item identifier directly or by transmitting the images to the online concierge system 140. Furthermore, the picker client device 110 determines a weight for items that are priced by weight. The picker client device 110 may prompt the picker to manually input the weight of an item or may communicate with a weighing system in the retailer location to receive the weight of an item.

When the picker has collected all of the items for an order, the picker client device 110 instructs a picker on where to deliver the items for a customer's order. For example, the picker client device 110 displays a delivery location from the order to the picker. The picker client device 110 also provides navigation instructions for the picker to travel from the retailer location to the delivery location. Where a picker is servicing more than one order, the picker client device 110 identifies which items should be delivered to which delivery location. The picker client device 110 may provide navigation instructions from the retailer location to each of the delivery locations. The picker client device 110 may receive one or more delivery locations from the online concierge system 140 and may provide the delivery locations to the picker so that the picker can deliver the corresponding one or more orders to those locations. The picker client device 110 may also provide navigation instructions for the picker from the retailer location from which the picker collected the items to the one or more delivery locations.

In some embodiments, the picker client device 110 tracks the location of the picker as the picker delivers orders to delivery locations. The picker client device 110 collects location data and transmits the location data to the online concierge system 140. The online concierge system 140 may transmit the location data to the customer client device 100 for display to the customer such that the customer can keep track of when their order will be delivered. Additionally, the online concierge system 140 may generate updated navigation instructions for the picker based on the picker's location. For example, if the picker takes a wrong turn while traveling to a delivery location, the online concierge system 140 determines the picker's updated location based on location data from the picker client device 110 and generates updated navigation instructions for the picker based on the updated location.

In one or more embodiments, the picker is a single person who collects items for an order from a retailer location and delivers the order to the delivery location for the order. Alternatively, more than one person may serve the role as a picker for an order. For example, multiple people may collect the items at the retailer location for a single order. Similarly, the person who delivers an order to its delivery location may be different from the person or people who collected the items from the retailer location. In these embodiments, each person may have a picker client device 110 that they can use to interact with the online concierge system 140.

Additionally, while the description herein may primarily refer to pickers as humans, in some embodiments, some or all of the steps taken by the picker may be automated. For example, a semi- or fully-autonomous robot may collect items in a retailer location for an order and an autonomous vehicle may deliver an order to a customer from a retailer location.

The retailer computing system 120 is a computing system operated by a retailer that interacts with the online concierge system 140. As used herein, a “retailer” is an entity that operates a “retailer location,” which is a store, warehouse, or other building from which a picker can collect items. The retailer computing system 120 stores and provides item data to the online concierge system 140 and may regularly update the online concierge system 140 with updated item data. For example, the retailer computing system 120 may provide item data indicating which items are available at a retailer location and the quantities of those items. Additionally, the retailer computing system 120 may transmit updated item data to the online concierge system 140 when an item is no longer available at the retailer location. Additionally, the retailer computing system 120 may provide the online concierge system 140 with updated item prices, sales, or availabilities. Additionally, the retailer computing system 120 may receive payment information from the online concierge system 140 for orders serviced by the online concierge system 140. Alternatively, the retailer computing system 120 may provide payment to the online concierge system 140 for some portion of the overall cost of a user's order (e.g., as a commission).

The customer client device 100, the picker client device 110, the retailer computing system 120, and the online concierge system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all standard layers used to describe a physical or virtual network, such as the physical layer, the data link layer, the network layer, the transport layer, the session layer, the presentation layer, and the application layer. The network 130 may include physical media for communicating data from one computing device to another computing device, such as MPLS lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online concierge system 140 is an online system by which customers can order items to be provided to them by a picker from a retailer. The online concierge system 140 receives orders from a customer client device 100 through the network 130. The online concierge system 140 selects a picker to service the customer's order and transmits the order to a picker client device 110 associated with the picker. The picker collects the ordered items from a retailer location and delivers the ordered items to the customer. The online concierge system 140 may charge a customer for the order and provides portions of the payment from the customer to the picker and the retailer.

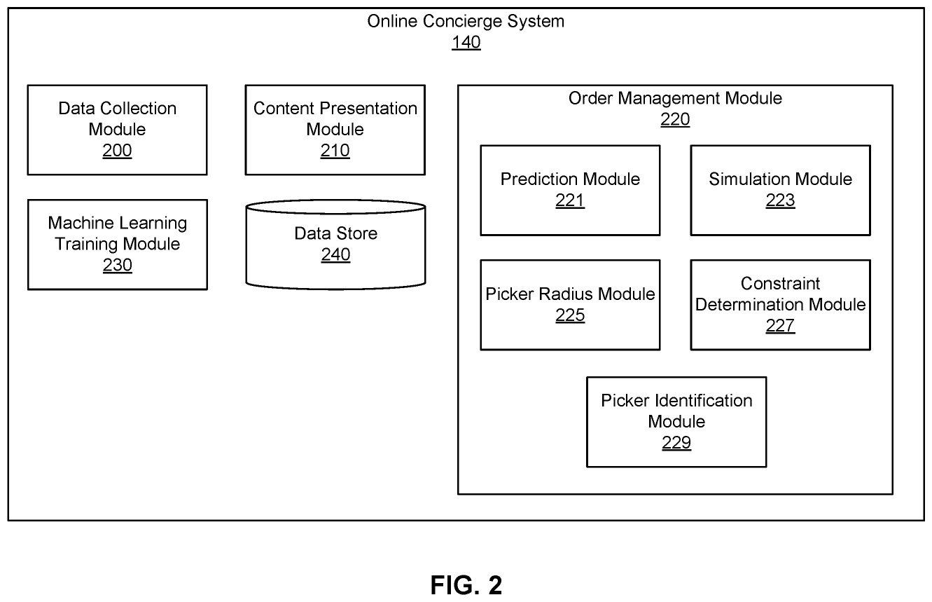

As an example, the online concierge system 140 may allow a customer to order groceries from a grocery store retailer. The customer's order may specify which groceries they want delivered from the grocery store and the quantities of each of the groceries. The customer client device 100 transmits the customer's order to the online concierge system 140 and the online concierge system 140 selects a picker to travel to the grocery store retailer location to collect the groceries ordered by the customer. Once the picker has collected the groceries ordered by the customer, the picker delivers the groceries to a location transmitted to the picker client device 110 by the online concierge system 140. The online concierge system 140 is described in further detail below with regards to FIG. 2.

FIG. 2 illustrates an example system architecture for an online concierge system 140, in accordance with some embodiments. The system architecture illustrated in FIG. 2 includes a data collection module 200, a content presentation module 210, an order management module 220, a machine learning training module 230, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online concierge system 140 and stores the data in the data store 240. The data collection module 200 may only collect data describing a user if the user has previously explicitly consented to the online concierge system 140 collecting data describing the user. Additionally, the data collection module 200 may encrypt all data, including sensitive or personal data, describing users.

For example, the data collection module 200 collects customer data, which is information or data that describe characteristics of a customer. Customer data may include a customer's name, address, shopping preferences, favorite items, or stored payment instruments. The customer data also may include default settings established by the customer, such as a default retailer/retailer location, payment instrument, delivery location, or delivery window. The data collection module 200 may collect the customer data from sensors on the customer client device 100 or based on the customer's interactions with the online concierge system 140.

The data collection module 200 also collects item data, which is information or data that identifies and describes items that are available at a retailer location. The item data may include item identifiers for items that are available and may include quantities of items associated with each item identifier. Additionally, item data may also include attributes of items such as the size, color, weight, stock keeping unit (SKU), or serial number for the items. The item data may further include purchasing rules associated with each item, if they exist. For example, age-restricted items such as alcohol and tobacco are flagged accordingly in the item data. Item data may also include information that is useful for predicting the availability of items in retailer locations. For example, for each item-retailer combination (a particular item at a particular retailer location), the item data may include a time that the item was last found, a time that the item was last not found (a picker looked for the item but could not find it), the rate at which the item is found, or the popularity of the item. The data collection module 200 may collect item data from a retailer computing system 120, a picker client device 110, or the customer client device 100.

An item category is a set of items that are a similar type of item. Items in an item category may be considered to be equivalent to each other or that may be replacements for each other in an order. For example, different brands of sourdough bread may be different items, but these items may be in a “sourdough bread” item category. The item categories may be human-generated and human-populated with items. The item categories also may be generated automatically by the online concierge system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online concierge system 140, a customer rating for the picker, which retailers the picker has collected items at, or the picker's previous shopping history. Additionally, the picker data may include preferences expressed by the picker, such as their preferred retailers to collect items at, how far they are willing to travel to deliver items to a customer, how many items they are willing to collect at a time, windows within which the picker is willing to service orders, or payment information by which the picker is to be paid for servicing orders (e.g., a bank account). The data collection module 200 collects picker data from sensors of the picker client device 110 or from the picker's interactions with the online concierge system 140.

Additionally, the data collection module 200 collects order data, which is information or data that describes characteristics of an order. For example, order data may include item data for items that are included in the order, a delivery location for the order, a customer associated with the order, a retailer location from which the customer wants the ordered items collected, or a window within which the customer wants the order delivered. Order data may further include information describing how the order was serviced, such as which picker serviced the order, when the order was delivered, or a rating that the customer gave the delivery of the order.

The content presentation module 210 selects content for presentation to a customer. For example, the content presentation module 210 selects which items to present to a customer while the customer is placing an order. The content presentation module 210 generates and transmits the ordering interface for the customer to order items. The content presentation module 210 populates the ordering interface with items that the customer may select for adding to their order. In some embodiments, the content presentation module 210 presents a catalog of all items that are available to the customer, which the customer can browse to select items to order. The content presentation module 210 also may identify items that the customer is most likely to order and present those items to the customer. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a customer. An item selection model is a machine learning model that is trained to score items for a customer based on item data for the items and customer data for the customer. For example, the item selection model may be trained to determine a likelihood that the customer will order the item. In some embodiments, the item selection model uses item embeddings describing items and customer embeddings describing customers to score items. These item embeddings and customer embeddings may be generated by separate machine learning models and may be stored in the data store 240.

In some embodiments, the content presentation module 210 scores items based on a search query received from the customer client device 100. A search query is text for a word or set of words that indicate items of interest to the customer. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a customer (e.g., by comparing a search query embedding to an item embedding).

In some embodiments, the content presentation module 210 scores items based on a predicted availability of an item. The content presentation module 210 may use an availability model to predict the availability of an item. An availability model is a machine learning model that is trained to predict the availability of an item at a retailer location. For example, the availability model may be trained to predict a likelihood that an item is available at a retailer location or may predict an estimated number of items that are available at a retailer location. The content presentation module 210 may weight the score for an item based on the predicted availability of the item. Alternatively, the content presentation module 210 may filter out items from presentation to a customer based on whether the predicted availability of the item exceeds a threshold.

The order management module 220 manages orders for items from customers. The order management module 220 receives orders from a customer client device 100 and assigns the orders to pickers for service based on picker data. For example, the order management module 220 assigns an order to a picker based on the picker's location and the retailer location from which the ordered items are to be collected. The order management module 220 may also assign an order to a picker based on how many items are in the order, a vehicle operated by the picker, the delivery location, the picker's preferences on how far to travel to deliver an order, the picker's ratings by customers, or how often a picker agrees to service an order.

Prior to assigning an order to a picker, the order management module 220 determines a minimum number of pickers to send a service request for the order. The order management module 220 may then identify a set of pickers to send the service request based on the determination and send the service request to a set of picker client devices 110 associated with the identified set of pickers. Components of the order management module 220 involved in this process include a prediction module 221, a simulation module 223, a picker radius module 225, a constraint determination module 227, and a picker identification module 229.

The prediction module 221 may access and apply an acceptance prediction model, which is a machine learning model that is trained to predict a likelihood that a picker will accept a service request for an order placed with the online concierge system 140. To apply the acceptance prediction model, the prediction module 221 may provide a set of inputs to the acceptance prediction model, in which the set of inputs may affect a level of appeal of an order to a picker. In some embodiments, the set of inputs may include attributes of the order or attributes of the picker. Attributes of the order may include an amount of earnings associated with the order (e.g., for servicing the order and a tip amount), a retailer associated with the order, a weight of each item included in the order, one or more tasks involved in servicing the order, a number of items or units included in the order, a volume associated with the order, or a type of item included in the order (e.g., alcohol, tobacco, etc.). Attributes of the order also may include a retailer location from which the items are to be collected, a delivery time associated with the order, a delivery location associated with the order, instructions that specify how the items should be collected, or any other suitable attributes. Attributes of the picker may include a current location associated with the picker (e.g., a location of a picker client device 110 associated with the picker), an availability of the picker to service orders, or preferences associated with the picker (e.g., how far to travel to deliver an order). Attributes of the picker also may include previous orders serviced by the picker, an age of the picker, a level of training completed by the picker, a customer rating for the picker, a vehicle operated by the picker, amounts of time it took for the picker to service previous orders, etc. In some embodiments, attributes of the picker also may be specific to the order and may include a travel distance/time associated with servicing the order, one or more costs associated with servicing the order (e.g., for parking, gas, tolls, etc.), or any other suitable attributes.

In various embodiments, the set of inputs provided to the acceptance prediction model by the prediction module 221 also may include information describing a demand side or a supply side associated with the online concierge system 140. Examples of information describing the demand side associated with the online concierge system 140 may include a number of orders placed with the online concierge system 140 or a rate at which orders are placed with the online concierge system 140, in which the orders are to be serviced within one or more windows or include items to be collected from retailer locations within one or more geographical zones (e.g., one or more zip codes, cities, counties, etc.). Similarly, examples of information describing the supply side associated with the online concierge system 140 may include a number of pickers available to service orders within one or more windows or geographical zones, a rate at which pickers are able to service orders within one or more windows or geographical zones, etc.

Once the prediction module 221 provides a set of inputs to the acceptance prediction model, the prediction module 221 may receive an output corresponding to a likelihood that a picker will accept a service request for an order. For example, suppose that the prediction module 221 provides a set of inputs to the acceptance prediction model, in which the set of inputs indicates an order is likely to be appealing to a picker (e.g., the order includes two small items and has a large tip amount, the picker's travel distance/time to a retailer location from which the items are to be collected and to the order's delivery location is short, etc.). In this example, if the prediction module 221 receives an output from the acceptance prediction model corresponding to a 94% likelihood, the output indicates there is a 94% likelihood that the picker will accept a service request for the order. As further described below, the acceptance prediction model may be trained by the machine learning training module 230.

The prediction module 221 also may access and apply a response prediction model, which is a machine learning model that is trained to predict a response of a set of pickers to a service request for an order placed with the online concierge system 140. In some embodiments, the response predicted by the response prediction model is a predicted acceptance response time corresponding to a predicted timespan between a sending of a service request for an order to a set of pickers and an acceptance of the service request by the set of pickers. For example, the response prediction model may be trained to predict a number of minutes between a time that a service request for an order is sent to a set of picker client devices 110 associated with a set of pickers and a time that a response accepting the service request is received from at least one picker client device 110 associated with the set of pickers.

The prediction module 221 may apply the response prediction model by providing a set of inputs to the response prediction model, in which the set of inputs may affect a level of appeal of an order to a set of pickers. In some embodiments, the set of inputs may include attributes of the order, as described above, a number of pickers included in the set of pickers, and a radius associated with the set of pickers, in which the radius is measured from a retailer location from which items included in the order are to be collected such that the set of pickers is associated with a set of locations within the radius of the retailer location. In some alternative embodiments, the radius is measured as a time that it would take to travel to the retailer location. In various embodiments, the set of inputs also may include attributes of the set of pickers or information describing the demand side or the supply side associated with the online concierge system 140, as also described above.

Once the prediction module 221 provides a set of inputs to the response prediction model, the prediction module 221 may receive an output corresponding to the predicted response of a set of pickers to a service request for an order. For example, suppose that the prediction module 221 provides a set of inputs to the response prediction model, in which the set of inputs indicates an order is unlikely to be appealing to a set of pickers (e.g., the order includes several large items and has a small tip amount, the travel distance/time to the retailer location is long for all five pickers included in the set of pickers, etc.). Continuing with this example, if the prediction module 221 receives an output from the response prediction model corresponding to 18 minutes, the output indicates that the average time for the pickers to accept the service request is predicted to be 18 minutes. As further described below, the response prediction model may be trained by the machine learning training module 230.

In some embodiments, the prediction module 221 also may access and apply a traveling time prediction model, which is a machine learning model that is trained to predict a traveling time for an order and a picker (i.e., a predicted amount of time it will take for the picker to travel when servicing the order). The prediction module 221 may apply the traveling time prediction model by providing a set of inputs to the traveling time prediction model, in which the set of inputs may affect an amount of time it takes for a picker to travel when servicing an order. In some embodiments, the set of inputs may include attributes of the order, attributes of the picker, or information describing the demand side or the supply side associated with the online concierge system 140, as described above. In various embodiments, the set of inputs also may include information describing other factors that may affect the amount of time it takes for the picker to travel when servicing the order. Examples of such factors include weather or traffic conditions associated with a route for servicing the order, detours taken by the picker, etc.

Once the prediction module 221 provides a set of inputs to the traveling time prediction model, the prediction module 221 may receive an output corresponding to a predicted traveling time for an order and a picker. For example, suppose that the prediction module 221 provides a set of inputs to the traveling time prediction model, in which the set of inputs indicates a traveling time for an order and a picker is likely to be short (e.g., the picker is a short distance from a retailer location from which items included in the order are to be collected, traffic conditions associated with a route for servicing the order are good, etc.). In this example, if the prediction module 221 receives an output from the traveling time prediction model corresponding to 15-20 minutes, the output indicates it will likely take the picker between 15 and 20 minutes to travel when servicing the order. As further described below, the traveling time prediction model may be trained by the machine learning training module 230.

The simulation module 223 accesses acceptance response times (e.g., from the data store 240). Acceptance response times correspond to timespans between the sending of service requests for previous orders placed with the online concierge system 140 to picker client devices 110 associated with pickers and the acceptance of the service requests received from the picker client devices 110. In some embodiments, the simulation module 223 may access a distribution of acceptance response times for one or more previous orders for one or more pickers. For example, a distribution of acceptance response times for a picker accessed by the simulation module 223 may include a number of service requests accepted by the picker within each of multiple windows (e.g., one minute, two minutes, three minutes, etc.) of the service requests being sent.

Beneficially, this simulation is performed to address limitations of machine learning technologies. In particular, there can be selection bias if one were to train the machine learning model using examples on real data, which can occur for a few reasons. For example, if the order is shown over time to multiple pickers (i.e., the order is not shown at once but instead over an increasing radius), and if a new batch of orders is created (e.g., at one time batches AB and C, and then at a later time batches AD and BC, where the letters indicate specific orders in a batch), the original batches may not exist, and the resulting training data could bias the model.

The simulation module 223 also generates a simulated response of a set of pickers to a service request. In some embodiments, the simulated response generated by the simulation module 223 may be a simulated acceptance response time of the set of pickers. For example, the simulated response generated by the simulation module 223 may correspond to a simulated number of minutes within which at least one picker included among the set of pickers accepts the service request. The simulation module 223 may generate the simulated response based on a likelihood that each picker included among the set of pickers will accept the service request for the order and a distribution of acceptance response times for one or more pickers included among the set of pickers. In some embodiments, the simulation module 223 may generate the simulated response by sampling distributions of acceptance response times. For example, suppose that the acceptance prediction model has predicted a likelihood that each picker included among a set of pickers will accept a service request for an order. In this example, suppose also that the simulation module 223 has accessed a distribution of acceptance response times for each picker having at least a threshold likelihood of accepting the service request. Continuing with this example, the simulation module 223 may then sample the distribution of acceptance response times for each picker having at least the threshold likelihood of accepting the service request (e.g., randomly or using any other suitable method). In this example, the simulation module 223 may then generate a simulated acceptance response time of the set of pickers corresponding to a minimum number of minutes sampled by the simulation module 223.

The picker radius module 225 identifies a plurality of sets of pickers based on a retailer location associated with an order. Each set of pickers identified by the picker radius module 225 may include a number of pickers associated with a set of locations within a radius of the retailer location, in which the number of pickers is proportional to the radius. For example, the picker radius module 225 may identify a plurality of sets of pickers based on a retailer location associated with an order, in which a first set of pickers includes five pickers, a second set of pickers includes 10 pickers, a third set of pickers includes 15 pickers, etc. In this example, each picker included among the first set of pickers is associated with a location within a one-mile radius of the retailer location, each picker included among the second set of pickers is associated with a location within a two-mile radius of the retailer location, each picker included among the third set of pickers is associated with a location within a three-mile radius of the retailer location, etc. In another example, the radii are measured based on travel times to the retailer location instead of geographical distances. A location associated with a picker may correspond to a location of a picker client device 110 associated with the picker tracked by the order management module 220, as further described below.

The constraint determination module 227 determines a minimum number of pickers to send a service request for an order. The constraint determination module 227 may do so based on a response to the service request predicted by the response prediction model for each set of pickers included among a plurality of sets of pickers and a delivery time associated with the order. In various embodiments, the constraint determination module 227 also may determine the minimum number of pickers to send the service request for the order based on a traveling time for the order and one or more pickers predicted by the traveling time prediction model. In some embodiments, the response to the service request predicted by the response prediction model for each set of pickers or the traveling time for the order and one or more pickers predicted by the traveling time prediction model may be used to generate one or more graphs, which the constraint determination module 227 may then use to determine the minimum number of pickers to send the service request for the order.

In embodiments in which the constraint determination module 227 determines a minimum number of pickers to send a service request for an order based on one or more graphs, the constraint determination module 227 may generate the graph(s). In some embodiments, the constraint determination module 227 may generate the graph(s) based on numbers of pickers included in each set of pickers included among a plurality of sets of pickers, an acceptance response time for a service request predicted for each set of pickers by the response prediction model, or traveling times for an order and one or more pickers included in each set of pickers predicted by the traveling time prediction model. For example, the constraint determination module 227 may generate a graph describing an expected acceptance response time for a service request by plotting a number of pickers included in each set of pickers along an x-axis and the acceptance response time predicted for each corresponding set of pickers along a y-axis. In the above example, the constraint determination module 227 also may generate a graph describing an expected traveling time for a corresponding order by plotting the number of pickers included in each set of pickers along an x-axis and the traveling time predicted for each corresponding set of pickers along a y-axis. In the above examples, the constraint determination module 227 also may generate a graph describing a sum of the expected acceptance response time for the service request and the expected traveling time for the corresponding order by plotting the number of pickers included in each set of pickers along an x-axis and the sum of the acceptance response time and traveling time predicted for each corresponding set of pickers along a y-axis. In the above example, the traveling time predicted for a set of pickers may correspond to an average traveling time predicted for the set of pickers, a traveling time predicted for a picker included in the set of pickers, in which the picker is associated with a shortest acceptance response time sampled by the simulation module 223, etc.

In embodiments in which the constraint determination module 227 generates one or more graphs, the constraint determination module 227 may determine a minimum number of pickers to send a service request for an order based on the graph(s) and a delivery time associated with the order. For example, suppose that based on a delivery time associated with an order, the order is scheduled to be delivered on time (e.g., the delivery time is within an average delivery window from a current time, in which the average delivery window is based on delivery windows for previous orders serviced during the same time of day or day of the week, etc.). In this example, the constraint determination module 227 may determine a minimum number of pickers to send a service request for the order by minimizing a sum of the acceptance response time for the service request predicted by the response prediction model for each set of pickers included among a plurality of sets of pickers and the traveling time predicted by the traveling time prediction model for each set of pickers. Continuing with this example, based on a graph describing a sum of the expected acceptance response time for the service request and the expected traveling time for the corresponding order, the minimum number of pickers may correspond to the number of pickers associated with the smallest sum. As an additional example, suppose that based on a delivery time associated with an order, the order is scheduled to be delivered ahead of schedule (e.g., the delivery time is more than half an hour after an average delivery window from a current time). In this example, the constraint determination module 227 may determine a minimum number of pickers to send a service request for the order by minimizing the traveling time predicted by the traveling time prediction model for each set of pickers included among a plurality of sets of pickers. Continuing with this example, based on a graph describing an expected traveling time for the order, the minimum number of pickers may correspond to the number of pickers associated with the shortest expected traveling time.

In some embodiments (e.g., if an order is scheduled to be delivered late), the constraint determination module 227 may determine a minimum number of pickers to send a service request for the order based on a delivery time associated with the order, but may disregard a response to the service request predicted by the response prediction model and a traveling time predicted by the traveling time prediction model. In such embodiments, the constraint determination module 227 may determine the minimum number of pickers to send the service request to ensure the order is serviced (e.g., based on a number of pickers within a geographical zone including a retailer location from which items included in the order are to be collected). For example, suppose that based on a delivery time associated with an order, the order is scheduled to be delivered late (e.g., the delivery time is prior to an average delivery window from a current time). In this example, the constraint determination module 227 may determine a minimum number of pickers to send a service request for the order to ensure the order is serviced, in which the minimum number of pickers corresponds to the number of pickers within a geographical zone including a retailer location from which items included in the order are to be collected.

In various embodiments, the constraint determination module 227 also may determine a minimum number of pickers to send a service request for an order based on a tolerance level for orders that may be delivered late. For example, if a maximum of 10% of orders placed with the online concierge system 140 may be delivered late, the constraint determination module 227 may determine a minimum number of pickers to send a service request for an order based on the tolerance level for orders that may be delivered late. In this example, the number of pickers may be determined such that the maximum percentage of orders that may be delivered late is not exceeded. In various embodiments, the constraint determination module 227 is configured to avoid late deliveries over a threshold amount at a beginning of a time period.

The picker identification module 229 may identify a set of pickers to send a service request for an order based on a set of constraints associated with the order, in which the set of constraints includes a minimum number of pickers to send the service request for the order determined by the constraint determination module 227. For example, the picker identification module 229 may identify a set of pickers to send a service request for an order such that the number of identified pickers equals or exceeds a minimum number of pickers specified in a set of constraints associated with the order. In some embodiments, a set of constraints associated with an order also may describe various factors that affect how or when the order may be serviced, who may service the order, or any other suitable types of constraints that may be associated with an order. For example, a set of constraints associated with an order may include an age restriction associated with one or more items included in the order, a minimum vehicle cargo space associated with a volume of items included in the order, a delivery time associated with the order, a delivery location associated with the order, a minimum level of training completed by pickers eligible to service the order, etc.

In some embodiments, an order may be included among multiple orders available for servicing by pickers and the picker identification module 229 may identify a set of pickers to send a service request for the order based on a function that minimizes costs for the online concierge system 140 while observing a set of constraints associated with each order. For example, the picker identification module 229 may identify a set of pickers to send a service request for each of multiple orders, in which the number of identified pickers equals or exceeds the minimum number of pickers specified in a set of constraints associated with each corresponding order. In this example, the picker identification module 229 also may identify the set of pickers by minimizing costs for the online concierge system 140, such that identified pickers are closest to a retailer location from which items included in a corresponding order are to be collected.

Once the picker identification module 229 has identified a set of pickers to send a service request for an order, the order management module 220 may send the service request to a set of picker client devices 110 associated with the set of pickers. The order management module 220 may then assign the order to a picker upon receiving a response accepting the service request from a picker client device 110 associated with the picker. For example, the order management module 220 may assign an order to a picker associated with the first picker client device 110 from which the order management module 220 receives a response accepting a corresponding service request.

In some embodiments, the order management module 220 may determine a minimum number of pickers to send a service request for a batch of orders, identify a set of pickers to send the service request, and send the service request to a set of picker client devices 110 associated with the set of pickers. A batch may include multiple orders that may be serviced by the same picker to whom the batch is assigned because it may be more efficient to have the same picker service the batch than to have different pickers service different orders included in the batch. For example, orders received by the order management module 220 during the same time interval may be included in the same batch to be serviced by the same picker based on a retailer location at which items included in each order are to be collected, a delivery location to which each order is to be delivered, etc. In embodiments in which the order management module 220 determines a minimum number of pickers to send a service request for a batch of orders, identifies a set of pickers to send the service request, and sends the service request to a set of picker client devices 110 associated with the set of pickers, the order management module 220 may do so in a manner analogous to that described above.

In some embodiments, the order management module 220 determines when to assign an order to a picker based on a delivery window requested by the customer who placed the order. The order management module 220 computes an estimated amount of time that it would take for a picker to collect the items for an order and deliver the ordered item to the delivery location for the order. The order management module 220 assigns the order to a picker at a time such that, if the picker immediately services the order, the picker is likely to deliver the order at a time within the window. Thus, when the order management module 220 receives an order, the order management module 220 may delay in assigning the order to a picker if the window is far enough in the future.

When the order management module 220 assigns an order to a picker, the order management module 220 transmits the order to the picker client device 110 associated with the picker. The order management module 220 may also transmit navigation instructions from the picker's current location to the retailer location associated with the order. If the order includes items to collect from multiple retailer locations, the order management module 220 identifies the retailer locations to the picker and may also specify a sequence in which the picker should visit the retailer locations.

The order management module 220 may track the location of the picker through the picker client device 110 to determine when the picker arrives at the retailer location. When the picker arrives at the retailer location, the order management module 220 transmits the order to the picker client device 110 for display to the picker. As the picker uses the picker client device 110 to collect items at the retailer location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the customer client device 100 that describe which items have been collected for the customer's order.

In some embodiments, the order management module 220 tracks the location of the picker within the retailer location. The order management module 220 uses sensor data from the picker client device 110 or from sensors in the retailer location to determine the location of the picker in the retailer location. The order management module 220 may transmit to the picker client device 110 instructions to display a map of the retailer location indicating where in the retailer location the picker is located. Additionally, the order management module 220 may instruct the picker client device 110 to display the locations of items for the picker to collect, and may further display navigation instructions for how the picker can travel from their current location to the location of a next item to collect for an order.

The order management module 220 determines when the picker has collected all of the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the retailer location to the delivery location, or to a subsequent retailer location for further item collection. The order management module 220 tracks the location of the picker as the picker travels to the delivery location for an order, and updates the customer with the location of the picker so that the customer can track the progress of their order. In some embodiments, the order management module 220 computes an estimated time of arrival for the picker at the delivery location and provides the estimated time of arrival to the customer.

In some embodiments, the order management module 220 facilitates communication between the customer client device 100 and the picker client device 110. As noted above, a customer may use a customer client device 100 to send a message to the picker client device 110. The order management module 220 receives the message from the customer client device 100 and transmits the message to the picker client device 110 for presentation to the picker. The picker may use the picker client device 110 to send a message to the customer client device 100 in a similar manner.

The order management module 220 coordinates payment by the customer for the order. The order management module 220 uses payment information provided by the customer (e.g., a credit card number or a bank account) to receive payment for the order. In some embodiments, the order management module 220 stores the payment information for use in subsequent orders by the customer. The order management module 220 computes a total cost for the order and charges the customer that cost. The order management module 220 may provide a portion of the total cost to the picker for servicing the order, and another portion of the total cost to the retailer.

The machine learning training module 230 trains machine learning models used by the online concierge system 140. The online concierge system 140 may use machine learning models to perform functionalities described herein. Example machine learning models include regression models, support vector machines, naïve bayes, decision trees, k nearest neighbors, random forest, boosting algorithms, k-means, and hierarchical clustering. The machine learning models may also include neural networks, such as perceptrons, multilayer perceptrons, convolutional neural networks, recurrent neural networks, sequence-to-sequence models, generative adversarial networks, or transformers.

Each machine learning model includes a set of parameters. A set of parameters for a machine learning model are parameters that the machine learning model uses to process an input. For example, a set of parameters for a linear regression model may include weights that are applied to each input variable in the linear combination that comprises the linear regression model. Similarly, the set of parameters for a neural network may include weights and biases that are applied at each neuron in the neural network. The machine learning training module 230 generates the set of parameters for a machine learning model by “training” the machine learning model. Once trained, the machine learning model uses the set of parameters to transform inputs into outputs.

The machine learning training module 230 trains a machine learning model based on a set of training examples. Each training example includes input data to which the machine learning model is applied to generate an output. For example, each training example may include customer data, picker data, item data, or order data. In some cases, the training examples also include a label which represents an expected output of the machine learning model. In these cases, the machine learning model is trained by comparing its output from input data of a training example to the label for the training example.

In embodiments in which the prediction module 221 accesses an acceptance prediction model that is trained to predict a likelihood that a picker will accept a service request for an order placed with the online concierge system 140, as described above, the machine learning training module 230 may train the acceptance prediction model. The machine learning training module 230 may train the acceptance prediction model via supervised learning based on attributes of pickers and attributes of previous orders placed with the online concierge system 140, in which service requests for the previous orders were sent to picker client devices 110 associated with the pickers. For example, the machine learning training module 230 may receive a set of training examples including attributes of a picker (e.g., preferences associated with the picker) and attributes of previous orders (e.g., amounts of earnings associated with the previous orders), in which a service request for each previous order was sent to a picker client device 110 associated with the picker. In this example, the machine learning training module 230 also may receive labels which represent expected outputs of the acceptance prediction model, in which a label indicates whether the picker accepted a service request for a previous order. Continuing with this example, the machine learning training module 230 may then train the acceptance prediction model based on the attributes of the picker, the attributes of the previous orders, and the labels by comparing its output from input data of each training example to the label for the training example. In some embodiments, the machine learning training module 230 also may train the acceptance prediction model based on historical data describing a demand side or a supply side associated with the online concierge system 140. Attributes of a picker, attributes of an order, and information describing a demand side or a supply side associated with the online concierge system 140 are described above.

In embodiments in which the prediction module 221 accesses a response prediction model that is trained to predict a response of a set of pickers to a service request for an order placed with the online concierge system 140, as described above, the machine learning training module 230 may train the response prediction model. The machine learning training module 230 may train the response prediction model via supervised learning based on attributes of orders placed with the online concierge system 140, simulated responses of sets of pickers to service requests for the orders, numbers of pickers included in the sets of pickers, and radii associated with the sets of pickers. A radius associated with a set of pickers is measured from a retailer location from which items included in an order are to be collected, such that each picker included among the set of pickers is associated with a location within the radius of the retailer location. The radius may be expressed as a geographical distance (e.g., a straight-line distance or a travel path distance) or may be a predicted travel time. For example, the machine learning training module 230 may receive a set of training examples including attributes of an order (e.g., an amount of earnings associated with the order and tasks involved in servicing the order), a number of pickers included in each set of pickers of a plurality of sets of pickers, and a radius associated with each set of pickers (e.g., a number of miles from a retailer location from which items included in the order are to be collected). In this example, the machine learning training module 230 also may receive labels which represent expected outputs of the response prediction model, in which a label is a simulated response of a set of pickers to a service request for the order. Continuing with this example, the machine learning training module 230 may then train the response prediction model based on the attributes of the order, the numbers of pickers included in the sets of pickers, the radii associated with the sets of pickers, and the labels by comparing its output from input data of each training example to the label for the training example. In some embodiments, the machine learning training module 230 also may train the response prediction model based on attributes of each picker included in each set of pickers and historical data describing a demand side or a supply side associated with the online concierge system 140. Attributes of a picker, attributes of an order, and information describing a demand side or a supply side associated with the online concierge system 140 are described above.

In embodiments in which the prediction module 221 accesses a traveling time prediction model that is trained to predict a traveling time for an order and a picker corresponding to a predicted amount of time it will take for the picker to travel when servicing the order. As described above, the machine learning training module 230 may train the traveling time prediction model. The machine learning training module 230 may train the traveling time prediction model via supervised learning based on attributes of previous orders placed with the online concierge system 140, attributes of pickers who serviced the previous orders, or historical data describing a demand side or a supply side associated with the online concierge system 140. For example, the machine learning training module 230 may receive a set of training examples including attributes of previous orders (e.g., retailer locations from which items included in the previous orders were to be collected and delivery locations for the previous orders) and attributes of pickers who serviced the previous orders (e.g., locations associated with the pickers when service requests for the previous orders were accepted). In this example, the set of training examples also include labels which represent expected outputs of the traveling time prediction model, in which a label indicates an amount of time it took for a picker to travel when servicing a previous order. Continuing with this example, the machine learning training module 230 may then train the traveling time prediction model based on the attributes of the previous orders, the attributes of the pickers, and the labels by comparing its output from input data of each training example to the label for the training example. In some embodiments, the machine learning training module 230 also may train the traveling time prediction model based on historical information describing other factors that may have affected the amount of time it took for a picker to travel when servicing an order. Attributes of a picker, attributes of an order, information describing a demand side or a supply side associated with the online concierge system 140, and information describing other factors that may affect the amount of time it takes for a picker to travel when servicing an order are described above.

The machine learning training module 230 may apply an iterative process to train a machine learning model whereby the machine learning training module 230 trains the machine learning model on each of the set of training examples. To train a machine learning model based on a training example, the machine learning training module 230 applies the machine learning model to the input data in the training example to generate an output. The machine learning training module 230 scores the output from the machine learning model using a loss function. A loss function is a function that generates a score for the output of the machine learning model such that the score is higher when the machine learning model performs poorly and lower when the machine learning model performs well. In cases where the training example includes a label, the loss function is also based on the label for the training example. Some example loss functions include the mean square error function, the mean absolute error, the hinge loss function, and the cross-entropy loss function. The machine learning training module 230 updates the set of parameters for the machine learning model based on the score generated by the loss function. For example, the machine learning training module 230 may apply gradient descent to update the set of parameters.

The data store 240 stores data used by the online concierge system 140. For example, the data store 240 stores customer data, item data, order data, and picker data for use by the online concierge system 140. The data store 240 also stores trained machine learning models trained by the machine learning training module 230. For example, the data store 240 may store the set of parameters for a trained machine learning model on one or more non-transitory, computer-readable media. The data store 240 uses computer-readable media to store data, and may use databases to organize the stored data. In some embodiments, the data store 240 also stores various types of data described above (e.g., acceptance response times, amounts of time it took for pickers to travel when servicing previous orders, information describing a demand side or a supply side associated with the online concierge system 140, information describing factors that may affect an amount of time it takes for a picker to travel when servicing an order, etc.).

Determining a Minimum Number of Pickers to Send a Service Request for an Order Placed with an Online Concierge System

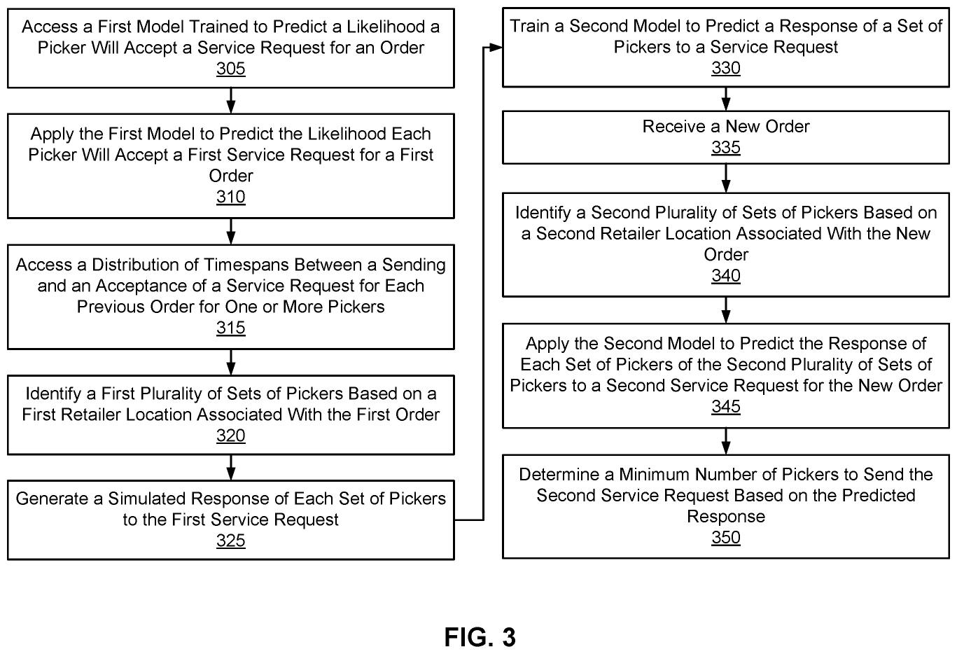

FIG. 3 is a flowchart of a method for determining a minimum number of pickers to send a service request for an order placed with an online concierge system 140, in accordance with some embodiments. Alternative embodiments may include more, fewer, or different steps from those illustrated in FIG. 3, and the steps may be performed in a different order from that illustrated in FIG. 3. These steps may be performed by an online concierge system (e.g., online concierge system 140). Additionally, each of these steps may be performed automatically by the online concierge system without human intervention.

The online concierge system 140 accesses 305 (e.g., using the prediction module 221) an acceptance prediction model. The acceptance prediction model is a machine learning model that is trained to predict a likelihood that a picker will accept a service request for an order placed with the online concierge system 140. In some embodiments, the acceptance prediction model is trained by the online concierge system 140 (e.g., using the machine learning training module 230).

The online concierge system 140 also applies 310 (e.g., using the prediction module 221) the acceptance prediction model to predict a likelihood that each picker of a plurality of pickers will accept a first service request for a first order placed with the online concierge system 140. The online concierge system 140 may apply 310 the acceptance prediction model by providing a set of inputs to the acceptance prediction model, in which the set of inputs may affect a level of appeal of the first order to a picker. In some embodiments, the set of inputs may include attributes of the first order or attributes of a picker. Attributes of the first order may include an amount of earnings associated with the first order (e.g., for servicing the first order and a tip amount), a retailer associated with the first order, a weight of each item included in the first order, one or more tasks involved in servicing the first order, a number of items or units included in the first order, a volume associated with the first order, etc. Attributes of the first order also may include a type of item included in the first order (e.g., alcohol, tobacco, etc.), a retailer location from which the items are to be collected, a delivery time associated with the first order, a delivery location associated with the first order, instructions that specify how the items should be collected, or any other suitable attributes. Attributes of a picker may include a current location associated with the picker (e.g., a location of a picker client device 110 associated with the picker), an availability of the picker to service orders, or preferences associated with the picker (e.g., how far to travel to deliver an order). Attributes of a picker also may include previous orders serviced by the picker, an age of the picker, a level of training completed by the picker, a customer rating for the picker, a vehicle operated by the picker, amounts of time it took for the picker to service previous orders, etc. In some embodiments, attributes of a picker also may be specific to the first order and may include a travel distance/time associated with servicing the first order, one or more costs associated with servicing the first order (e.g., for parking, gas, tolls, etc.), or any other suitable attributes.

In various embodiments, the set of inputs provided to the acceptance prediction model by the online concierge system 140 also may include information describing a demand side or a supply side associated with the online concierge system 140. Examples of information describing the demand side associated with the online concierge system 140 may include a number of orders placed with the online concierge system 140 or a rate at which orders are placed with the online concierge system 140, in which the orders are to be serviced within one or more windows or include items to be collected from retailer locations within one or more geographical zones (e.g., one or more zip codes, cities, counties, etc.). Similarly, examples of information describing the supply side associated with the online concierge system 140 may include a number of pickers available to service orders within one or more windows or geographical zones, a rate at which pickers are able to service orders within one or more windows or geographical zones, etc.

Once the online concierge system 140 provides a set of inputs to the acceptance prediction model, the online concierge system 140 may receive an output corresponding to a likelihood that a picker will accept the first service request for the first order. For example, suppose that the online concierge system 140 provides a set of inputs to the acceptance prediction model, in which the set of inputs indicates the first order is likely to be appealing to a picker (e.g., the first order includes two small items and has a large tip amount, the picker's travel distance/time to a retailer location from which the items are to be collected and to the first order's delivery location is short, etc.). In this example, if the online concierge system 140 receives an output from the acceptance prediction model corresponding to a 94% likelihood, the output indicates there is a 94% likelihood that the picker will accept the first service request for the first order.

The online concierge system 140 accesses (step 315, e.g., using the simulation module 223) acceptance response times (e.g., from the data store 240) for one or more pickers of the plurality of pickers. As described above, acceptance response times correspond to timespans between the sending of service requests for previous orders placed with the online concierge system 140 to picker client devices 110 associated with pickers and the acceptance of the service requests received from the picker client devices 110. In some embodiments, the online concierge system 140 may access 315 a distribution of acceptance response times for one or more previous orders for the picker(s). For example, a distribution of acceptance response times for a picker accessed 315 by the online concierge system 140 may include a number of service requests accepted by the picker within each of multiple windows (e.g., one minute, two minutes, three minutes, etc.) of the service requests being sent.

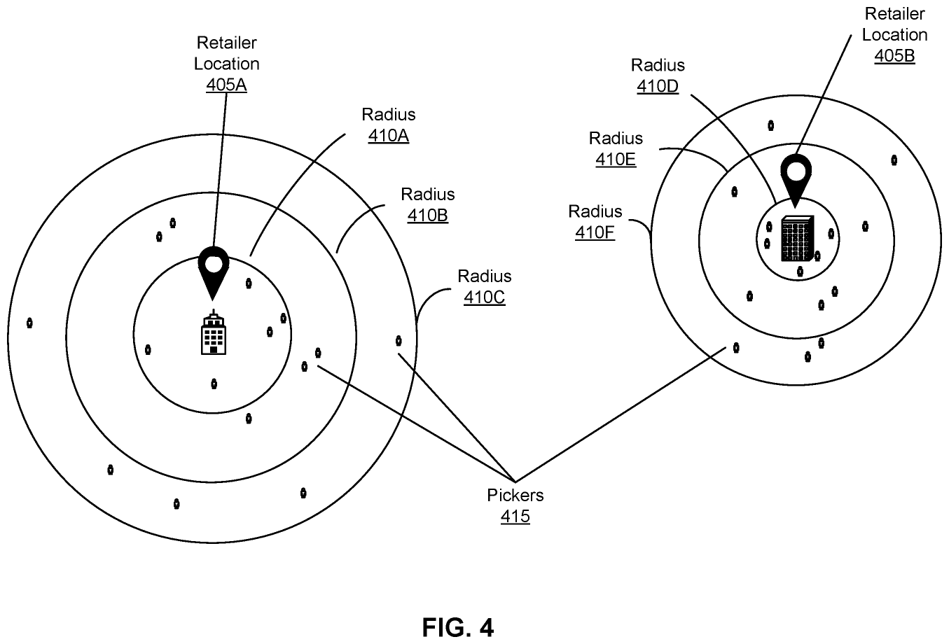

The online concierge system 140 then identifies 320 (e.g., using the picker radius module 225) a first plurality of sets of pickers from the plurality of pickers. The online concierge system 140 may identify 320 the first plurality of sets of pickers based on a first retailer location associated with the first order. Each set of pickers identified 320 by the online concierge system 140 may include a first number of pickers associated with a set of locations within a first radius of the first retailer location, in which the first number of pickers is proportional to the first radius. An example is shown in FIG. 4, which illustrates examples of pickers 415 associated with locations within different radii 410 of different retailer locations 405, in accordance with one or more embodiments. In this example, the online concierge system 140 may identify 320 the first plurality of sets of pickers 415 based on the first retailer location 405A associated with the first order, in which a first set of pickers 415 includes five pickers 415, a second set of pickers 415 includes 10 pickers 415, a third set of pickers 415 includes 15 pickers 415, etc. In this example, each picker 415 included among the first set of pickers 415 is associated with a location within a one-mile radius 410A of the first retailer location 405A, each picker 415 included among the second set of pickers 415 is associated with a location within a two-mile radius 410B of the first retailer location 405A, each picker 415 included among the third set of pickers 415 is associated with a location within a three-mile radius 410C of the first retailer location 405A, etc. A location associated with a picker 415 may correspond to a location of a picker client device 110 associated with the picker 415 tracked by the online concierge system 140 (e.g., using the order management module 220).

Referring back to FIG. 3, the online concierge system 140 generates 325 (e.g., using the simulation module 223) a simulated response of each set of pickers 415 of the first plurality of sets of pickers 415 to the first service request. In some embodiments, the simulated response generated 325 by the online concierge system 140 may be a simulated acceptance response time of each set of pickers 415. For example, the simulated response generated 325 by the online concierge system 140 may correspond to a simulated number of minutes within which at least one picker 415 included among each set of pickers 415 accepts the first service request. The online concierge system 140 may generate 325 the simulated response based on the likelihood that each picker 415 will accept the first service request for the first order and the distribution of acceptance response times for one or more pickers 415 (e.g., one or more pickers 415 included in each set of pickers 415). In some embodiments, the online concierge system 140 may generate 325 the simulated response by sampling distributions of acceptance response times. For example, suppose that the acceptance prediction model has predicted a likelihood that each picker 415 included among a set of pickers 415 will accept the first service request for the first order. In this example, suppose also that the online concierge system 140 has accessed 315 the distribution of acceptance response times for each picker 415 having at least a threshold likelihood of accepting the first service request. Continuing with this example, the online concierge system 140 may then sample the distribution of acceptance response times for each picker 415 having at least the threshold likelihood of accepting the first service request (e.g., randomly or using any other suitable method). In this example, the online concierge system 140 may then generate 325 the simulated acceptance response time of the set of pickers 415 corresponding to a minimum number of minutes sampled by the online concierge system 140.

The online concierge system 140 may then train 330 (e.g., using the machine learning training module 230) a response prediction model to predict a response of a set of pickers 415 to a service request for an order placed with the online concierge system 140. In some embodiments, the response predicted by the response prediction model is a predicted acceptance response time corresponding to a predicted timespan between a sending of a service request for an order to a set of pickers 415 and an acceptance of the service request by the set of pickers 415. For example, the response prediction model may be trained 330 to predict a number of minutes between a time that a service request for an order is sent to a set of picker client devices 110 associated with a set of pickers 415 and a time that a response accepting the service request is received from at least one picker client device 110 associated with the set of pickers 415.

The online concierge system 140 may train 330 the response prediction model via supervised learning based on a set of attributes of the first order, the simulated response of each set of pickers 415 of the first plurality of sets of pickers 415 to the first service request for the first order, and a corresponding number of pickers 415 and first radius 410. For example, the online concierge system 140 may receive a set of training examples including attributes of the first order (e.g., an amount of earnings associated with the first order and tasks involved in servicing the first order), a number of pickers 415 included in each set of pickers 415, and a first radius 410 associated with each set of pickers 415 (e.g., a number of miles from the first retailer location 405A from which items included in the first order are to be collected). In this example, the online concierge system 140 also may receive labels which represent expected outputs of the response prediction model, in which a label is a simulated response of a set of pickers 415 of the first plurality of sets of pickers 415 to the first service request for the first order. Continuing with this example, the online concierge system 140 may then train 330 the response prediction model based on the attributes of the first order, the numbers of pickers 415 included in the sets of pickers 415, the radii 410 associated with the sets of pickers 415, and the labels by comparing its output from input data of each training example to the label for the training example. In some embodiments, the online concierge system 140 also may train 330 the response prediction model based on attributes of each picker 415 included in each set of pickers 415 and historical data describing a demand side or a supply side associated with the online concierge system 140. Attributes of a picker 415, attributes of an order, and information describing a demand side or a supply side associated with the online concierge system 140 are described above.

The online concierge system 140 then receives 335 (e.g., via the order management module 220) a new order placed with the online concierge system 140. For example, the online concierge system 140 receives 335 the new order from a customer client device 100 associated with a customer. In this example, order data associated with the new order received 335 by the online concierge system 140 may include various attributes of the new order, such as an amount of earnings associated with the new order (e.g., for servicing the new order and a tip amount), a retailer associated with the new order, a weight of each item included in the new order, one or more tasks involved in servicing the new order, etc. In the above example, attributes of the new order also may include a number of items or units included in the new order, a volume associated with the new order, a type of item included in the new order (e.g., alcohol, tobacco, etc.), a retailer location 405 from which the items are to be collected, a delivery time associated with the new order, a delivery location associated with the new order, instructions that specify how the items should be collected, or any other suitable attributes.

The online concierge system 140 identifies 340 (e.g., using the picker radius module 225) a second plurality of sets of pickers 415 from the plurality of pickers 415. The online concierge system 140 may identify 340 the second plurality of sets of pickers 415 based on a second retailer location 405 associated with the new order. Each set of pickers 415 identified 340 by the online concierge system 140 may include a second number of pickers 415 associated with a set of locations within a second radius 410 of the second retailer location 405, in which the second number of pickers 415 is proportional to the second radius 410. For example, as shown in FIG. 4, the online concierge system 140 may identify 340 the second plurality of sets of pickers 415 based on the second retailer location 405B associated with the new order, in which a first set of pickers 415 includes five pickers 415, a second set of pickers 415 includes 10 pickers 415, a third set of pickers 415 includes 15 pickers 415, etc. In this example, each picker 415 included among the first set of pickers 415 is associated with a location within a half-mile radius 410D of the second retailer location 405B, each picker 415 included among the second set of pickers 415 is associated with a location within a one-mile radius 410E of the second retailer location 405B, each picker 415 included among the third set of pickers 415 is associated with a location within a two-mile radius 410F of the second retailer location 405B, etc. As described above, a location associated with a picker 415 may correspond to a location of a picker client device 110 associated with the picker 415 tracked by the online concierge system 140 (e.g., using the order management module 220).

Referring again to FIG. 3, for each set of pickers 415 of the second plurality of sets of pickers 415, the online concierge system 140 may access and apply 345 (e.g., using the prediction module 221) the response prediction model to predict the response of a corresponding set of pickers 415 to a second service request for the new order. The online concierge system 140 may apply 345 the response prediction model by providing a set of inputs to the response prediction model, in which the set of inputs may affect a level of appeal of the new order to a set of pickers 415. In some embodiments, the set of inputs may include attributes of the new order and a corresponding second number of pickers 415 and second radius 410. In various embodiments, the set of inputs also may include attributes of the set of pickers 415 or information describing the demand side or the supply side associated with the online concierge system 140, as described above.

Once the online concierge system 140 provides a set of inputs to the response prediction model, the online concierge system 140 may receive an output corresponding to the predicted response of a set of pickers 415 to the second service request for the new order. For example, suppose that the online concierge system 140 provides a set of inputs to the response prediction model, in which the set of inputs indicates the new order is unlikely to be appealing to a set of pickers 415 (e.g., the new order includes several large items and has a small tip amount, the travel distance/time to the second retailer location 405B is long for all five pickers 415 included in the set of pickers 415, etc.). Continuing with this example, if the online concierge system 140 receives an output from the response prediction model corresponding to 18 minutes, the output indicates that at least one picker 415 included among the set of five pickers 415 will likely accept the second service request within 18 minutes.

In some embodiments, the online concierge system 140 also may access and apply (e.g., using the prediction module 221) a traveling time prediction model, which is a machine learning model that is trained to predict a traveling time for an order and a picker 415 (i.e., a predicted amount of time it will take for the picker 415 to travel when servicing the order). In such embodiments, the online concierge system 140 may apply the traveling time prediction model to predict a traveling time for the new order and a picker 415 by providing a set of inputs to the traveling time prediction model, in which the set of inputs may affect an amount of time it takes for the picker 415 to travel when servicing the new order. In some embodiments, the set of inputs may include attributes of the new order, attributes of a picker 415, or information describing the demand side or the supply side associated with the online concierge system 140, as described above. In various embodiments, the set of inputs also may include information describing other factors that may affect the amount of time it takes for a picker 415 to travel when servicing the new order. Examples of such factors include weather or traffic conditions associated with a route for servicing the new order, detours taken by the picker 415, etc.

Once the online concierge system 140 provides a set of inputs to the traveling time prediction model, the online concierge system 140 may receive an output corresponding to a predicted traveling time for the new order and a picker 415. For example, suppose that the online concierge system 140 provides a set of inputs to the traveling time prediction model, in which the set of inputs indicates the traveling time for the new order and a picker 415 is likely to be short (e.g., the picker is a short distance from the second retailer location 405B, traffic conditions associated with a route for servicing the new order are good, etc.). In this example, if the online concierge system 140 receives an output from the traveling time prediction model corresponding to 15-20 minutes, the output indicates it will likely take the picker 415 between 15 and 20 minutes to travel when servicing the new order. In some embodiments, the traveling time prediction model may be trained by the online concierge system 140 (e.g., using the machine learning training module 230).

The online concierge system 140 then determines 350 (e.g., using the constraint determination module 227) a minimum number of pickers 415 to send the second service request for the new order. The online concierge system 140 may do so based on the response to the second service request predicted by the response prediction model for each set of pickers 415 included among the second plurality of sets of pickers 415 and a delivery time associated with the new order. In various embodiments, the online concierge system 140 also may determine 350 the minimum number of pickers 415 to send the second service request for the new order based on a traveling time for the new order and one or more pickers 415 of the plurality of pickers 415 predicted by the traveling time prediction model. In some embodiments, the response to the second service request predicted by the response prediction model for each set of pickers 415 or the traveling time for the new order and one or more pickers 415 predicted by the traveling time prediction model may be used to generate one or more graphs, which the online concierge system 140 may then use to determine 350 the minimum number of pickers 415 to send the second service request for the new order.

In embodiments in which the online concierge system 140 determines 350 the minimum number of pickers 415 to send the second service request for the new order based on one or more graphs, the online concierge system 140 may generate the graph(s) (e.g., using the constraint determination module 227). In some embodiments, the online concierge system 140 may generate the graph(s) based on numbers of pickers 415 included in each set of pickers 415 included among the second plurality of sets of pickers 415, an acceptance response time for the second service request predicted for each set of pickers 415 by the response prediction model, or traveling times for the new order and one or more pickers 415 included in each set of pickers 415 predicted by the traveling time prediction model.

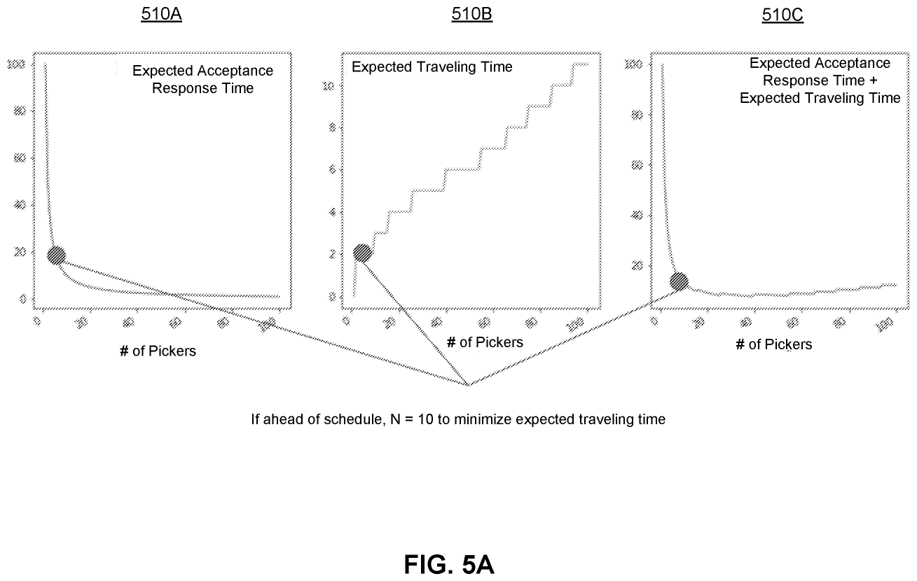

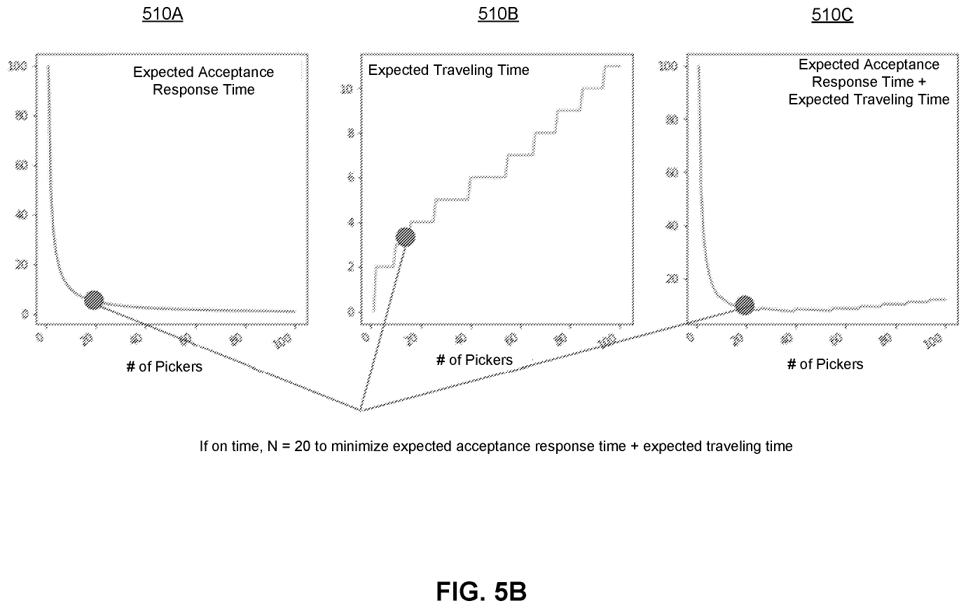

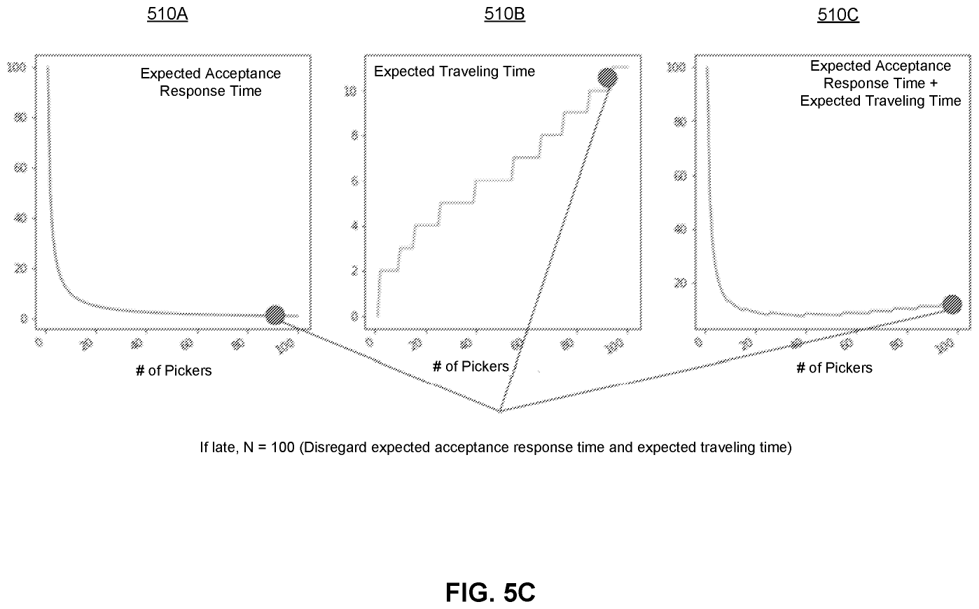

FIGS. 5A-5C illustrate examples of graphs 510 for determining 350 a minimum number of pickers 415 to send a service request for an order placed with an online concierge system 140, in accordance with one or more embodiments. As shown in the examples, the online concierge system 140 may generate graph 510A describing an expected acceptance response time for the second service request by plotting a number of pickers 415 included in each set of pickers 415 along an x-axis and the acceptance response time predicted for each corresponding set of pickers 415 along a y-axis. In the above example, the online concierge system 140 also may generate graph 510B describing an expected traveling time for the new order by plotting the number of pickers 415 included in each set of pickers 415 along an x-axis and the traveling time predicted for each corresponding set of pickers 415 along a y-axis. In the above examples, the online concierge system 140 also may generate graph 510C describing a sum of the expected acceptance response time for the second service request and the expected traveling time for the new order by plotting the number of pickers 415 included in each set of pickers 415 along an x-axis and the sum of the acceptance response time and traveling time predicted for each corresponding set of pickers 415 along a y-axis. In the above example, the traveling time predicted for a set of pickers 415 may correspond to an average traveling time predicted for the set of pickers 415, a traveling time predicted for a picker 415 included in the set of pickers 415, in which the picker 415 is associated with a shortest acceptance response time sampled by the online concierge system 140, etc.

In embodiments in which the online concierge system 140 generates one or more graphs 510, the online concierge system 140 may determine 350 the minimum number of pickers 415 to send the second service request for the new order based on the graph(s) 510 and the delivery time associated with the new order. For example, as shown in FIG. 5A, suppose that based on the delivery time associated with the new order, the new order is scheduled to be delivered ahead of schedule (e.g., the delivery time is more than half an hour after an average delivery window from a current time, in which the average delivery window is based on delivery windows for previous orders serviced during the same time of day or day of the week, etc.). In this example, the online concierge system 140 may determine 350 the minimum number of pickers 415 to send the second service request for the new order by minimizing the traveling time predicted by the traveling time prediction model for each set of pickers 415 included among the second plurality of sets of pickers 415. Continuing with this example, based on graph 510B describing an expected traveling time for the new order, the minimum number of pickers 415 (i.e., 10) may correspond to the number of pickers 415 associated with the shortest expected traveling time. As an additional example, as shown in FIG. 5B, suppose that based on the delivery time associated with the new order, the new order is scheduled to be delivered on time (e.g., the delivery time is within an average delivery window from a current time). In this example, the online concierge system 140 may determine 350 the minimum number of pickers 415 to send the second service request for the new order by minimizing a sum of the acceptance response time for the second service request predicted by the response prediction model for each set of pickers 415 included among the second plurality of sets of pickers 415 and the traveling time predicted by the traveling time prediction model for each set of pickers 415. Continuing with this example, based on graph 510C describing a sum of the expected acceptance response time for the second service request and the expected traveling time for the new order, the minimum number of pickers 415 (i.e., 20) may correspond to the number of pickers 415 associated with the smallest sum.

In some embodiments (e.g., if the new order is scheduled to be delivered late), the online concierge system 140 may determine 350 the minimum number of pickers 415 to send the second service request for the new order based on the delivery time associated with the new order, but may disregard the response to the second service request predicted by the response prediction model and the traveling time predicted by the traveling time prediction model. In such embodiments, the online concierge system 140 may determine 350 the minimum number of pickers 415 to send the second service request to ensure the new order is serviced (e.g., based on a number of pickers 415 within a geographical zone including the second retailer location 405B from which items included in the new order are to be collected). For example, as shown in FIG. 5C, suppose that based on the delivery time associated with the new order, the new order is scheduled to be delivered late (e.g., the delivery time is prior to an average delivery window from a current time). In this example, the online concierge system 140 may disregard graphs 510A-C and determine 350 a minimum number of pickers 415 (i.e., 100) to send the second service request for the new order to ensure the new order is serviced (e.g., based on a number of pickers 415 available within a geographical zone including the second retailer location 405B).

In various embodiments, the online concierge system 140 also may determine 350 the minimum number of pickers 415 to send the second service request for the new order based on a tolerance level for orders that may be delivered late. For example, if a maximum of 10% of orders placed with the online concierge system 140 may be delivered late, the online concierge system 140 may determine 350 the minimum number of pickers 415 to send the second service request for the new order based on the tolerance level for orders that may be delivered late. In this example, the number of pickers 415 may be determined 350 such that the maximum percentage of orders that may be delivered late is not exceeded.

The online concierge system 140 may then identify (e.g., using the picker identification module 229) a set of pickers 415 to send the second service request for the new order based on a set of constraints associated with the new order, in which the set of constraints includes the minimum number of pickers 415 to send the service request for the new order determined 350 by the online concierge system 140. For example, the online concierge system 140 may identify the set of pickers 415 to send the second service request for the new order such that the number of identified pickers 415 equals or exceeds the minimum number of pickers 415 specified in a set of constraints associated with the new order. In some embodiments, the set of constraints associated with the new order also may describe various factors that affect how or when the new order may be serviced, who may service the new order, or any other suitable types of constraints that may be associated with the new order. For example, the set of constraints associated with the new order may include an age restriction associated with one or more items included in the new order, a minimum vehicle cargo space associated with a volume of items included in the new order, the delivery time associated with the new order, a delivery location associated with the new order, a minimum level of training completed by pickers 415 eligible to service the new order, etc.

In some embodiments, the new order may be included among multiple new orders available for servicing by pickers 415 and the online concierge system 140 may identify the set of pickers 415 to send the second service request for the new order based on a function that minimizes costs for the online concierge system 140 while observing a set of constraints associated with each new order. For example, the online concierge system 140 may identify a set of pickers 415 to send a service request for each of multiple new orders, in which the number of identified pickers 415 equals or exceeds the minimum number of pickers 415 specified in a set of constraints associated with each corresponding new order. In this example, the online concierge system 140 also may identify the set of pickers 415 by minimizing costs for the online concierge system 140, such that identified pickers 415 are closest to a retailer location 405 from which items included in a corresponding new order are to be collected.

Once the online concierge system 140 has identified the set of pickers 415 to send the second service request for the new order, the online concierge system 140 may send (e.g., using the order management module 220) the second service request to a set of picker client devices 110 associated with the set of pickers 415. The online concierge system 140 may then assign (e.g., using the order management module 220) the new order to a picker 415 upon receiving a response accepting the second service request from a picker client device 110 associated with the picker 415. For example, the online concierge system 140 may assign the new order to a picker 415 associated with the first picker client device 110 from which the online concierge system 140 receives a response accepting the second service request.

In some embodiments, the online concierge system 140 alternatively may determine 350 a minimum number of pickers 415 to send a service request for a batch of new orders, identify a set of pickers 415 to send the service request, and send the service request to a set of picker client devices 110 associated with the set of pickers 415. A batch may include multiple orders that may be serviced by the same picker 415 to whom the batch is assigned because it may be more efficient to have the same picker 415 service the batch than to have different pickers 415 service different orders included in the batch. For example, orders received by the online concierge system 140 during the same time interval may be included in the same batch to be serviced by the same picker 415 based on a retailer location 405 at which items included in each order are to be collected, a delivery location to which each order is to be delivered, etc. In embodiments in which the online concierge system 140 determines 350 a minimum number of pickers 415 to send a service request for a batch of new orders, identifies a set of pickers 415 to send the service request, and sends the service request to a set of picker client devices 110 associated with the set of pickers 415, the online concierge system 140 may do so in a manner analogous to that described above.

### ADDITIONAL CONSIDERATIONS

The foregoing description of the embodiments has been presented for the purpose of illustration; a person of ordinary skill in the art would recognize that many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include any embodiment of a computer program product or other data combination described herein.

The description herein may describe processes and systems that use machine learning models in the performance of their described functionalities. A “machine learning model,” as used herein, comprises one or more machine learning models that perform the described functionality. Machine learning models may be stored on one or more computer-readable media with a set of weights. These weights are parameters used by the machine learning model to transform input data received by the model into output data. The weights may be generated through a training process, whereby the machine learning model is trained based on a set of training examples and labels associated with the training examples. The training process may include: applying the machine learning model to a training example, comparing an output of the machine learning model to the label associated with the training example, and updating weights associated with the machine learning model through a back-propagation process. The weights may be stored on one or more computer-readable media, and are used by a system when applying the machine learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present), A is false (or not present) and B is true (or present), and both A and B are true (or present). Similarly, a condition “A, B, or C” is satisfied by any combination of A, B, and C being true (or present). As a not-limiting example, the condition “A, B, or C” is satisfied when A and B are true (or present) and C is false (or not present). Similarly, as another not-limiting example, the condition “A, B, or C” is satisfied when A is true (or present) and B and C are false (or not present).

What is claimed is:

1. A method comprising, at a computer system comprising a processor and a computer-readable medium:
accessing a first machine learning model trained to predict a likelihood that a picker will accept a service request for an order placed with an online concierge system;
applying the first machine learning model to predict the likelihood that each picker of a plurality of pickers will accept a first service request for a first order;
accessing a distribution of timespans between a sending and an acceptance of a service request for one or more previous orders for one or more pickers of the plurality of pickers;
identifying a first plurality of sets of pickers from the plurality of pickers based at least in part on a first retailer location associated with the first order, wherein each set of pickers of the first plurality of sets of pickers comprises a first number of pickers associated with a set of locations within a first radius of the first retailer location and the first number of pickers is proportional to the first radius;
generating a simulated response of each set of pickers of the first plurality of sets of pickers to the first service request based at least in part on the likelihood that each picker of the plurality of pickers will accept the first service request for the first order and the distribution of timespans;
training a second machine learning model to predict a response of a set of pickers to a service request based at least in part on a set of attributes of the first order, the simulated response generated for each set of pickers of the first plurality of sets of pickers, and a corresponding first number of pickers and first radius;
receiving a new order placed with the online concierge system;
identifying a second plurality of sets of pickers from the plurality of pickers based at least in part on a second retailer location associated with the new order, wherein each set of pickers of the second plurality of sets of pickers comprises a second number of pickers associated with a set of locations within a second radius of the second retailer location and the second number of pickers is proportional to the second radius;
for each set of pickers of the second plurality of sets of pickers, applying the second machine learning model to predict the response of a corresponding set of pickers to a second service request for the new order based at least in part on the set of attributes of the new order and a corresponding second number of pickers and second radius; and
determining a minimum number of pickers to send the second service request for the new order based at least in part on the response predicted for each set of pickers of the second plurality of sets of pickers and a delivery time associated with the new order.

2. The method of claim 1, wherein the response predicted for each set of pickers of the second plurality of sets of pickers comprises a timespan between a sending of the second service request for the new order to the corresponding set of pickers and an acceptance of the second service request for the new order by the corresponding set of pickers.

3. The method of claim 2, wherein the minimum number of pickers to send the second service request for the new order is determined by minimizing the timespan between a sending of the second service request for the new order to the corresponding set of pickers and an acceptance of the second service request for the new order by the corresponding set of pickers.

4. The method of claim 1, further comprising:
accessing a third machine learning model trained to predict an amount of time it will take for a picker to travel when servicing an order placed with the online concierge system; and
applying the third machine learning model to predict the amount of time it will take for one or more pickers of the plurality of pickers to travel when servicing the new order.

5. The method of claim 4, wherein determining the minimum number of pickers to send the second service request for the new order is further based at least in part on the predicted amount of time it will take for one or more pickers of the plurality of pickers to travel when servicing the new order.

6. The method of claim 5, wherein the minimum number of pickers to send the second service request for the new order is determined by minimizing a sum of the timespan between a sending of the second service request for the new order to the corresponding set of pickers and an acceptance of the second service request for the new order by the corresponding set of pickers and the predicted amount of time it will take for one or more pickers of the plurality of pickers to travel when servicing the new order.

7. The method of claim 1, further comprising:
identifying a set of pickers of the plurality of pickers to send the second service request for the new order based at least in part on a set of constraints associated with each new order of a plurality of new orders, wherein the set of constraints comprises the minimum number of pickers to send the second service request for the new order; and
sending the second service request for the new order to a set of picker client devices associated with the identified set of pickers.

8. The method of claim 1, wherein determining the minimum number of pickers to send the second service request for the new order comprises:
generating one or more graphs based at least in part on the response predicted for each set of pickers of the second plurality of sets of pickers; and
determining the minimum number of pickers to send the second service request for the new order based at least in part on the one or more graphs and the delivery time associated with the new order.

9. The method of claim 1, wherein the set of attributes comprises one or more of: an amount of earnings associated with an order, a retailer associated with an order, a weight associated with an order, one or more tasks involved in servicing an order, a number of items included in an order, a volume associated with an order, a type of item included in an order, a retailer location at which one or more items included in an order are to be collected, a delivery time associated with an order, a delivery location associated with an order, and instructions specifying how one or more items included in an order are to be collected.

10. The method of claim 1, wherein training the second machine learning model is further based at least in part on information describing a demand side and a supply side associated with the online concierge system.

11. A computer program product comprising a non-transitory computer readable storage medium having instructions encoded thereon that, when executed by a processor, cause the processor to:
access a first machine learning model trained to predict a likelihood that a picker will accept a service request for an order placed with an online concierge system;
apply the first machine learning model to predict the likelihood that each picker of a plurality of pickers will accept a first service request for a first order;
access a distribution of timespans between a sending and an acceptance of a service request for one or more previous orders for one or more pickers of the plurality of pickers;
identify a first plurality of sets of pickers from the plurality of pickers based at least in part on a first retailer location associated with the first order, wherein each set of pickers of the first plurality of sets of pickers comprises a first number of pickers associated with a set of locations within a first radius of the first retailer location and the first number of pickers is proportional to the first radius;
generate a simulated response of each set of pickers of the first plurality of sets of pickers to the first service request based at least in part on the likelihood that each picker of the plurality of pickers will accept the first service request for the first order and the distribution of timespans;
train a second machine learning model to predict a response of a set of pickers to a service request based at least in part on a set of attributes of the first order, the simulated response generated for each set of pickers of the first plurality of sets of pickers, and a corresponding first number of pickers and first radius;
receive a new order placed with the online concierge system;
identify a second plurality of sets of pickers from the plurality of pickers based at least in part on a second retailer location associated with the new order, wherein each set of pickers of the second plurality of sets of pickers comprises a second number of pickers associated with a set of locations within a second radius of the second retailer location and the second number of pickers is proportional to the second radius;
for each set of pickers of the second plurality of sets of pickers, apply the second machine learning model to predict the response of a corresponding set of pickers to a second service request for the new order based at least in part on the set of attributes of the new order and a corresponding second number of pickers and second radius; and
determine a minimum number of pickers to send the second service request for the new order based at least in part on the response predicted for each set of pickers of the second plurality of sets of pickers and a delivery time associated with the new order.

12. The computer program product of claim 11, wherein the response predicted for each set of pickers of the second plurality of sets of pickers comprises a timespan between a sending of the second service request for the new order to the corresponding set of pickers and an acceptance of the second service request for the new order by the corresponding set of pickers.

13. The computer program product of claim 12, wherein the minimum number of pickers to send the second service request for the new order is determined by minimizing the timespan between a sending of the second service request for the new order to the corresponding set of pickers and an acceptance of the second service request for the new order by the corresponding set of pickers.

14. The computer program product of claim 11, wherein the computer-readable storage medium further has instructions encoded thereon that, when executed by the processor, cause the processor to:
access a third machine learning model trained to predict an amount of time it will take for a picker to travel when servicing an order placed with the online concierge system; and
apply the third machine learning model to predict the amount of time it will take for one or more pickers of the plurality of pickers to travel when servicing the new order.

15. The computer program product of claim 14, wherein determine the minimum number of pickers to send the second service request for the new order is further based at least in part on the predicted amount of time it will take for one or more pickers of the plurality of pickers to travel when servicing the new order.

16. The computer program product of claim 15, wherein the minimum number of pickers to send the second service request for the new order is determined by minimizing a sum of the timespan between a sending of the second service request for the new order to the corresponding set of pickers and an acceptance of the second service request for the new order by the corresponding set of pickers and the predicted amount of time it will take for one or more pickers of the plurality of pickers to travel when servicing the new order.

17. The computer program product of claim 11, wherein the computer-readable storage medium further has instructions encoded thereon that, when executed by the processor, cause the processor to:
identify a set of pickers of the plurality of pickers to send the second service request for the new order based at least in part on a set of constraints associated with each new order of a plurality of new orders, wherein the set of constraints comprises the minimum number of pickers to send the second service request for the new order; and
send the second service request for the new order to a set of picker client devices associated with the identified set of pickers.

18. The computer program product of claim 11, wherein determine the minimum number of pickers to send the second service request for the new order comprises:
generate one or more graphs based at least in part on the response predicted for each set of pickers of the second plurality of sets of pickers; and
determine the minimum number of pickers to send the second service request for the new order based at least in part on the one or more graphs and the delivery time associated with the new order.

19. The computer program product of claim 11, wherein the set of attributes comprises one or more of: an amount of earnings associated with an order, a retailer associated with an order, a weight associated with an order, one or more tasks involved in servicing an order, a number of items included in an order, a volume associated with an order, a type of item included in an order, a retailer location at which one or more items included in an order are to be collected, a delivery time associated with an order, a delivery location associated with an order, and instructions specifying how one or more items included in an order are to be collected.

20. A computer system comprising:
a processor; and
a non-transitory computer readable storage medium storing instructions that, when executed by the processor, cause the processor to perform actions comprising:
accessing a first machine learning model trained to predict a likelihood that a picker will accept a service request for an order placed with an online concierge system;
applying the first machine learning model to predict the likelihood that each picker of a plurality of pickers will accept a first service request for a first order;
accessing a distribution of timespans between a sending and an acceptance of a service request for one or more previous orders for one or more pickers of the plurality of pickers;
identifying a first plurality of sets of pickers from the plurality of pickers based at least in part on a first retailer location associated with the first order, wherein each set of pickers of the first plurality of sets of pickers comprises a first number of pickers associated with a set of locations within a first radius of the first retailer location and the first number of pickers is proportional to the first radius;
generating a simulated response of each set of pickers of the first plurality of sets of pickers to the first service request based at least in part on the likelihood that each picker of the plurality of pickers will accept the first service request for the first order and the distribution of timespans;
training a second machine learning model to predict a response of a set of pickers to a service request based at least in part on a set of attributes of the first order, the simulated response generated for each set of pickers of the first plurality of sets of pickers, and a corresponding first number of pickers and first radius;
receiving a new order placed with the online concierge system;
identifying a second plurality of sets of pickers from the plurality of pickers based at least in part on a second retailer location associated with the new order, wherein each set of pickers of the second plurality of sets of pickers comprises a second number of pickers associated with a set of locations within a second radius of the second retailer location and the second number of pickers is proportional to the second radius;
for each set of pickers of the second plurality of sets of pickers, applying the second machine learning model to predict the response of a corresponding set of pickers to a second service request for the new order based at least in part on the set of attributes of the new order and a corresponding second number of pickers and second radius; and
determining a minimum number of pickers to send the second service request for the new order based at least in part on the response predicted for each set of pickers of the second plurality of sets of pickers and a delivery time associated with the new order.
